(19) United States
(12) Patent Application Publication
(10) Pub. No.: US 2006/0168507 A1
(43) Pub. Date: Jul. 27, 2006

(54) Apparatus, system, and method for digitally presenting the contents of a printed publication

(76) Inventor: Kim D. Hansen, Salem, UT (US)

Correspondence Address: KUNZLER & ASSOCIATES, 8 EAST BROADWAY, SUITE 600, SALT LAKE CITY, UT, 84111, US

(21) Appl. No.: 11/341,245

(22) Filed: Jan. 26, 2006

Related U.S. Application Data
(60) Provisional application No. 60/647,085, filed on Jan. 26, 2005.

(51) Int. Cl. G06F 17/21; H04N 5/445; G06F 13/00; G06F 17/00; G06F 15/00; G06F 17/24; G06F 3/00

(52) U.S. Cl. 715/500.1; 715/501.1; 715/513; 725/42

(57) ABSTRACT

An apparatus, system, and method are disclosed for digitally presenting the contents of a printed publication. In one embodiment, the method includes obtaining contents of the printed publication, determining text content and graphical content; and providing one or more digital playback files configured to selectively present audio data and visual data corresponding to the text content and graphical content of the printed publication, wherein the audio data and the visual data are synchronized. The method may also include obtaining advertisement content and coordinating the audio data and the visual data to playback the advertisement content interspersed with the contents of the printed publication.

### CROSS-REFERENCES TO RELATED APPLICATIONS

This application is a continuation-in-part of and claims priority to U.S. Provisional Patent Application No. 60/647,085 entitled “AUDIO PERIODICAL” and filed on Jan. 26, 2005 for Kim D. Hansen, which is incorporated herein by reference.

### BACKGROUND OF THE INVENTION

1. Field of the Invention

This invention relates to audio presentations of printed publications and more particularly relates to digital audio and visual presentations of printed publications.

2. Description of the Related Art

Publications such as magazines, newspapers, trade journals, books, instruction manuals, and the like, are printed and distributed to consumers on a frequent basis and provide instruction, entertainment, and information to keep the public informed of current issues. Printed publications, particularly periodicals, typically are sold at point-of-sale stations or ordered through a regular subscription. Printed publications generally include pages with text and illustrations.

In today's fast-paced society, many people feel pressed for time to accomplish daily activities, including reviewing publications. “Multi-tasking” has become the paradigm for efficiency. Commuters traveling to and from work often dedicate travel time to reading a favorite book or magazine. Those driving frequently listen to radio programs or audio books. Mealtime is regularly combined with other activities, such as watching the news or reading a newspaper.

Reflective of the public's desire for efficiency and combined activities, portable devices such as CD and MP3 players, cellular phones, PDAs and the like have gained popularity, enabling users to multi-task while on the go. Listening to music, news broadcasts, and other audio programs is a particularly popular activity. Technological advances have further enabled the public to access the internet through various hand-held devices. The widespread use of portable devices indicates a common desire for convenience and portability. In particular, hand-held playback devices that have audio and visual capabilities, such as MP3 players, are in high demand.

Recently, electronic versions of printed publications including periodicals are also commonly available to internet users through wired or wireless connections. Internet websites typically comprise periodical information and subscription information as well as text articles (often features in the printed periodical) represented in HTML format with associated graphics. These “online editions” of printed periodical, in certain instances, provide supplemental information or viewing options through exclusive video footage, PDF download files, search engines, hyperlinks, and the like. The websites, however, generally require internet access to view the featured content and are difficult to navigate from portable devices. Downloaded files can be large and may occupy a large portion of storage space on a storage medium. Furthermore, the electronic versions generally do not offer an audio version of the featured content and are mainly visual in nature. People “on the go” generally prefer printed versions of periodicals because the printed periodicals are portable and easy to navigate.

A popular product currently available to facilitate “multi-tasking” in certain instances includes audio books available on tapes, CDs, and recently, in MP3 format. An audio rendering of popular books benefits many different types of people, including the blind, people who have difficulty reading, or those who enjoy listening to audio programs while performing other activities, such as driving or cooking, for example. One commodity that is not readily available is a portable audio version of regularly published periodicals.

Some services such as the National Library Service for the Blind and Physically Handicapped (NLS) provide recorded tapes or CDs of requested periodicals to those who qualify for special services. These types of audio recordings, however, are not readily available to the public and have limited functionality. Particularly, because these audio renditions are prepared for the blind, the simple voice recordings are not enhanced with corresponding text or relevant visual images to provide a visually stimulating presentation. In addition, the presentations are typically low budget and do not feature listening options or special features. Consequently, the audio presentations can be boring and undesirable, which may be true for audio books as well.

On the other hand, others have proposed advanced digital magazines that may be distributed over the internet and the like, which include superior audio capabilities, integrated graphics and videos, etc. Unfortunately, these types of electronic magazines also typically require special application software and the like to view the features. As a result, the content is not easily portable and is incompatible with common portable devices. Furthermore, such digital magazines lack printed counterparts, which may be more suited for users in circumstances special application software is unavailable.

Electronic books are associated with similar problems. To view or listen to the featured content, proprietary software and/or electronic readers are required, which limit the options of the user. Electronic readers, though available for decades, remain unpopular when compared to printed publications.

From the foregoing discussion, it should be apparent that a need exists for an apparatus, system, and method for digitally presenting the contents of a printed publication that is portable and accommodates a busy lifestyle. Beneficially, such an apparatus, system, and method would enable a user to listen to an audio presentation of a printed publication and simultaneously provide corresponding visual content, thus enhancing the overall digital presentation. In addition, the apparatus, system, and method would be distributable in a commonly used file format such that an audio presentation may be playable on various playback devices. Furthermore, the user would be able to optionally listen to the audio version or view the corresponding printed version depending on the circumstances and/or user preferences.

### SUMMARY OF THE INVENTION

The present invention has been developed in response to the present state of the art, and in particular, in response to the problems and needs in the art that have not yet been fully solved by currently available printed publications and audio or digital counterparts. Accordingly, the present invention has been developed to provide an apparatus, system, and method for digitally presenting the contents of a printed periodical that overcome many or all of the above-discussed shortcomings in the art.

The apparatus, in one embodiment, is configured to selectively present the contents of a printed publication in a digital playback format. The apparatus may include text content and graphical content of the printed publication and one or more digital playback files configured to selectively present audio data and visual data corresponding to the text content and the graphical content of the printed publication, and wherein the audio data and the visual data are synchronized. In certain embodiments, the text content and the graphical content are coordinated to playback consecutively relative to the printed layout of the printed publication. Alternatively, the user may select the presentation format. In certain embodiments, the digital playback file selectively plays relative to a playback device.

In one embodiment, the visual data is coordinated to trigger in time at a given time relative to the audio data. The visual data may be visual content from the printed publication or may be supplementary visual data to enhance the content presentation. In certain embodiments, the visual data is selected from the group consisting of graphical images, graphical image sequences, video files, pictures, and animations. The animations may include Flash, Java, Adobe file format, or the like.

In certain embodiments, the audio data comprises a voice recording of the text content of the printed publication. In one embodiment, the voice recording is a human voice talent. Alternatively, the audio data may be generated by an automated computer voice. In a contemplated embodiment, the voice recording is selectable from a plurality of voice recordings. The user may select a particular dialect, language, child voice, male and female voices, a particular reader, a celebrity, or the like. In addition, the audio data, or the sound recording, may include one or more sound bytes or audio enhancements to increase the entertainment value and listening quality of the audio presentation.

The text content may be revised, abridged, expanded, or the like to create a pleasing digital audio presentation. In one embodiment, the contents of the printed periodical include advertisement content that is integrated into the digital playback file. In addition, the contents, or at least a portion of a written segment, such as an article, chapter, summary, or the like, is included in the digital playback file and may be associated with a searchable identifier. Consequently, the user may search a database for a digital playback file of a complete publication or a segment of a publication according to a selected identifier.

A system of the present invention is also presented for digitally presenting the contents of a printed publication. The system may be embodied in a computer network in certain embodiments. In particular, the system, in one embodiment, includes text content and graphical content of the printed publication, one or more digital playback files configured to selectively present audio data and visual data corresponding to the text content and graphical content of the printed publication, wherein the audio data and the visual data are synchronized, and a server configured to store one or more digital audio playback files, the server comprising a searchable database accessible through a network.

In one embodiment, the system further comprises an electronic kiosk in communication with the server. The electronic kiosk may accept payment and transfer one or more digital playback files to either a client computer system or a portable storage medium, including a portable playback device. In yet another embodiment, the system includes a communication network, such as internet radio, satellite radio, short wave radio, traditional bandwidth radio, and the like.

A method of the present invention is also presented for digitally presenting the contents of a printed periodical. The method in the disclosed embodiments substantially includes the steps necessary to carry out the functions presented above with respect to the operation of the described apparatus and system. In one embodiment, the method includes obtaining contents of the printed publication, determining text content and graphical content; and providing one or more digital playback files configured to selectively present audio data and visual data corresponding to the text content and graphical content of the printed publication, wherein the audio data and the visual data are synchronized.

The method may also include obtaining advertisement content and coordinating the audio data and the visual data to playback the advertisement content interspersed with the contents of the printed publication. In certain embodiments, a hyperlink connects the contents to a related source. For example, a hyperlink may connect advertisement content with an advertiser website, an online magazine, an email address, or the like. In one embodiment, the advertiser may track the number of users referred through the hyperlink.

In a further embodiment, the method includes storing the digital playback file on a storage medium. The storage medium may be incorporated in a server or client computer system, a portable storage medium, a portable playback device, or the like. In one embodiment, a portable storage medium containing the digital playback file is distributed whole or in part with the corresponding printed publication.

In an alternative embodiment, the method includes broadcasting the audio data and visual data over a communication network. Furthermore, the method may include distributing the digital playback file on a network according to a consumer profile. For example, the consumer may subscribe to receive a digital audio presentation of a regularly distributed publication through an internet connection. In certain instances, the digital audio presentation, or the digital playback file, may be automatically downloaded to a client computer system or the like according to the consumer request.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention enables the contents of a printed publication to be digitally presented in a playback file that is common to many computer systems. The user may simultaneously listen to an audio presentation and view the graphical contents of the publication if desired. These features and advantages of the present invention will become more fully apparent from the following description and appended claims, or may be learned by the practice of the invention as set forth hereinafter.

co

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a presentation system for digitally presenting the contents of a printed publication in accordance with the present invention;

FIG. 2 is a schematic block diagram illustrating one embodiment of a storage and delivery system for digitally presenting the contents of a printed publication in accordance with the present invention;

FIG. 3 is a schematic block diagram illustrating an alternative embodiment of a storage and delivery system for digitally presenting the contents of a printed publication in accordance with the present invention;

FIG. 4 is a schematic block diagram illustrating another embodiment of a storage and delivery system for digitally presenting the contents of a printed publication in accordance with the present invention;

FIG. 5 is a schematic block diagram illustrating one embodiment of an audio presentation for digitally presenting the contents of a printed publication in accordance with the present invention; and

FIG. 6 is a schematic flow chart diagram illustrating one embodiment of a presentation method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

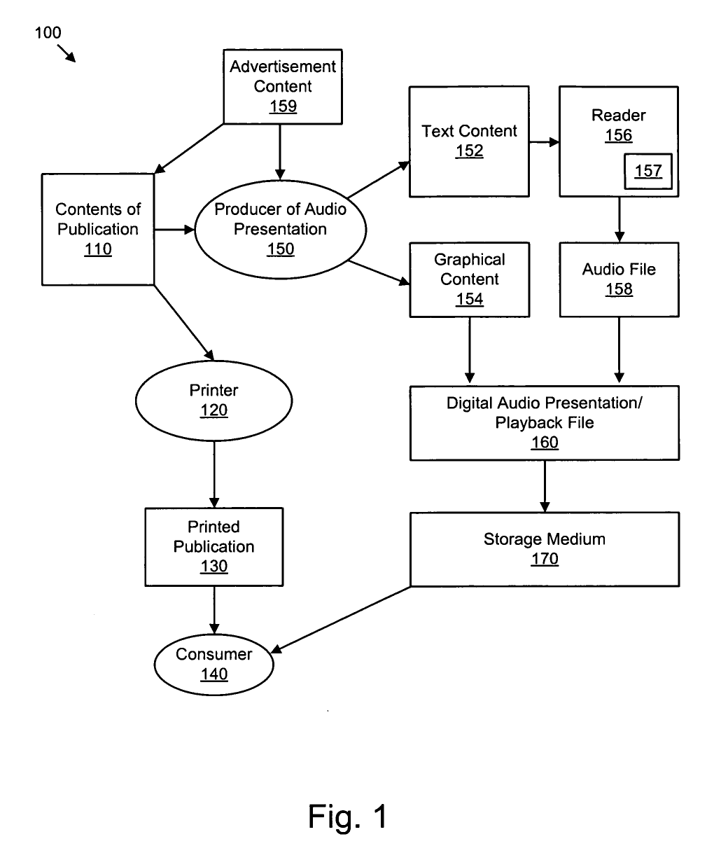

FIG. 1 depicts one embodiment of a presentation system 100 for digitally presenting the contents of a printed publication. The presentation system 100, as depicted, comprises contents 110 of a publication, a printer 120, a printed publication 130, a consumer 140, a producer 150 of an audio presentation, a digital audio presentation 160 or digital playback file 160, and a storage medium 170. The printer 120 produces a printed version of the publication 130 based on the contents 110 received from a publisher or the like. Similarly, a producer 150 produces an audio presentation 160 from the same publication contents 110. As a result, the consumer 140 may benefit from both the printed publication 130 and a digital audio presentation 160 of the same publication 130.

The publication 130 may include any work that is printed and distributed, including, but not limited to, books, magazines, newspapers, trade journals, instruction manuals, information sheets, and the like. Publications 130 generally comprise pages of text and may include photos, graphics, illustrations, or the like to enhance the publication 130.

In one embodiment, the contents 110 of the publication are classed as text content 152 and graphical content 154. Text content 152 may include all written text typical to printed publications 130, such as text from the articles of the publication 130, advertisements, titles, subtitles, and the like. Graphical content 154 may include advertisements, images from the articles, scanned images of pages of the printed publication 130, graphics, and the like. In certain embodiments, the graphical content 154 may further include video footage, commercials, animations, graphic sequences, and the like.

In certain embodiments, the contents 110 of the publication 130 may be abridged or expanded to create the digital audio presentation 160. For example, the contents 110 may be expanded to include video, animations, recorded interviews, and other visual and/or audio effects that are not achievable with printed materials. Alternatively, the contents 110 may be abridged, for example, in order to conform to a digital file size or the like. In certain embodiments, contents 110 may be abridged to provide a summary, synopsis, short form, or revised edition of the contents 110.

In certain embodiments, the contents 110 of the publication 130 may include advertisement content. For example, periodicals, such as magazines, trade journals, newspapers and the like, commonly include advertisements as a key element of a business strategy. Advertisements are known to be profitable to both the publisher of the periodical and the advertiser. Text content 152 and/or graphical content 154 may be determined for the advertisements printed in the publication 130. In one embodiment, the producer 150 of the audio presentation 160 determines an audio script that features text content of the advertisement and/or the name of the advertiser. The graphical content 154, in certain embodiments, may be a graphic image of the printed advertisement.

Alternatively or in addition, advertisement content 159 may be provided by a supplementary advertiser, or an advertiser providing supplementary material. For example, an advertiser providing a printed advertisement for the printed publication 130 may additionally supply a video clip, an advertorial, a hyperlink, a radio/audio advertisement, an animation, a multimedia presentation, or the like to the producer 150 of the digital audio presentation to add variety and interest to the audio presentation 160. Advertisement content 159 may be condensed or expanded to suit the needs of the advertiser, the publisher, and/or the producer 150, format limits, or the like. Advertisement content 159 may be contracted and added to publications 130 lacking substantial advertisement content 159.

The selected text content 152 may be assigned to one or more readers 156. A reader 156, in certain embodiments, may be automated by using specialized applications, such as text to speech software or the like. Alternatively, live readers 156 (actual people) may be employed to produce an audio file 158 of the selected text content 152. In one embodiment, the author of an article, a celebrity, or known radio personality may be contracted to read one or more segments or articles from a publication 130. One or more audio files 158 may be made from the contents 110 of the publication 130. In one embodiment, the audio file 158 corresponds verbatim to the selected text content 152 from a publication 130. Alternatively, the audio file 158 may contain a summary, revision, or the like of the text content 152.

In one embodiment, the readers 156 convert the text content 152 in time with a sound effects track 157 or an audio enhancement such as a sound byte 157. The sound effects track 157 may be produced by the producer 150 to enhance the listening experience. In certain embodiments, the sound effects track 157 may comprise a variety of different sounds, tunes, jingles, songs, song clips, or the like that may relate directly or indirectly to the subject matter of the text content 152. For example, an article about a bow hunt may include sound effects resembling background noises commonly heard on a bow hunt, such as the rustling of an animal in the brush, an animal call, the twang of a bow string, the flight of an arrow, and the like.

In another example, text content 152 may refer to a new song recently released and then play a portion of the song as a sound effect for the audio file 158. Alternatively or in addition, the sound effects may include background sounds, background music, trademark jingles, songs, sounds or music for a particular magazine or the like. The sound effects may add a level of suspense or anticipation depending on the tone and content of the subject matter of the text content 152. Those of skill in the art will recognize the broad range of sound effects that may comprise a sound effects track 157 suitable for use with the present invention.

In one embodiment, a digital audio presentation 160 is created by matching visual content 154 from an article to the text content 152 in an audio file 158. Consequently, the audio data and the visual data may be synchronized. The text content 152 and the visual content 154 may be organized to playback relative to the order of the layout of the printed publication 130. For example, a printed article containing three images (an illustration, a graph, and a photo) may be arranged into an audio presentation 160 that comprises an audible narration of the text content 152 with cued images corresponding to the verbalized text. Consequently, the user may listen to the audio presentation 160 of the publication 130 while simultaneously viewing relative images designated to be shown at a certain point within the reading of the text.

In certain embodiment, the visual data is triggered at a selected location in the audio file 158. In one embodiment, the visual data is coordinated to trigger in time at a given time relative to the audio data. The visual data may be cued relative to a time sequence, a location in the audio file 158, a marker in the text, the audio content, a manual selection, an audible or non-audible signal, and the like. In certain embodiments, the audio file 158 may correspond to a text file and graphical content may be may be cued relative to key words.

The digital audio presentation 160 may be stored on a storage medium 170 to facilitate distribution of the presentation 160. In certain embodiments, a portable storage medium 170 may include, but is not limited to, compact disk (CD), Digital Video Disk (DVD), flash memory, magnetic disk, SD card, mini disk, and mobile playback device.

In one embodiment, the audio presentation 160 is stored on a portable storage device and distributed with the printed publication 130. Alternatively, the audio presentation 160 may be shipped directly to the consumer 140. In certain embodiments, the audio presentation 160 is downloaded from a server and stored on a client computer system, portable playback device, or the like.

In select embodiments, the storage medium 170 comprises a disk in CD or DVD format that functions in players with standard formatting. Consequently, the storage medium 170 does not require special application software or the like to enable the user to listen to and/or view publication content 110. In a contemplated embodiment, the disk may be printed with images that correspond to the cover of the printed publication 130. Thus, users may easily recognize that the disk contains content from the printed publication 130. In one embodiment, the cover artwork varies with each publication issued, such as in the case of printed periodical magazine. Alternatively, the cover artwork may have a standard template that includes portions of the original cover art and a few main headlines.

In one embodiment, a CD containing all or part of the digital audio presentation 160 is distributed collectively with the printed publication 130. For example, a printed magazine may be distributed with a CD containing at least one digital playback file 160 containing audio data and visual data from the content of at least a portion of a written segment, such as a feature article. The CD may also contain an advertisement for the magazine and a hyperlink connecting the consumer 140 to a website where the consumer 140 may subscribe to the digital audio version of the magazine and/or to a regular mail subscription. The consumer 140 may subsequently download a full or abridged version of the magazine, an article, a selection of articles, a selection of articles from different publications, or the like. The CD informs the consumer of the audio presentation 160 and further advertises for the magazine and conceivably other products as well.

In one embodiment, audio files are stored in MP3 format. Consequently, an audio presentation of a printed magazine 230 may be played on a standard MP3 player. MP3 players are typically small and easily portable, which enables the user to transport the audio presentation 160. In one embodiment, the audio and/or visual data may be streamable from a server or website. Consequently, publication content may be viewed on wired or wireless devices capable of receiving content from the internet. One example of an audio/visual streaming file is Microsoft's Advanced Streaming Format (ASF), which may contain video, audio, slide shows, and synchronized events. Windows Media File (WMF) may also contain audio/visual files and may be downloaded from distant servers. Playback files such as ASF or WMF may also be available on other storage media including CDs, memory sticks, hard drives, flash memory drives, USB drives, and the like including new forms of storage media.

The user may be able to listen to an audio presentation 160 of publication content 110 while s/he is driving or performing other activities. In one embodiment, a CD or the like contains separate audio tracks for each article of a periodical, including an editorial track that explains the contents of the articles. Advertisement tracks featuring advertisement content 159 may also be included. Alternatively, the advertisement content 159 may be featured within an audio track featuring an article, for example. In one embodiment, the advertisement content 159 is interspersed with the contents of the printed publication.

The audio presentation 160 may be stored in multiple formats on a DualDisc, which is CD formatted on one side and DVD formatted on the other side, thereby enabling the disk to play in both a CD player and DVD player (which are being installed more frequently in vehicles). Straight audio tracks may be stored on the CD side of the disk, while video, special interviews and the like may be stored on the DVD side of the disk. Alternatively, the audio presentation may be recorded along with graphic images and/or video on a Video CD (VCD), Super Video CD (SVCD), CVD, or the like. Those of skill in the art will recognize that the digital audio presentation 160 may be formatted in various file formats and stored on multiple storage media. The invention, therefore, is not limited to the given examples.

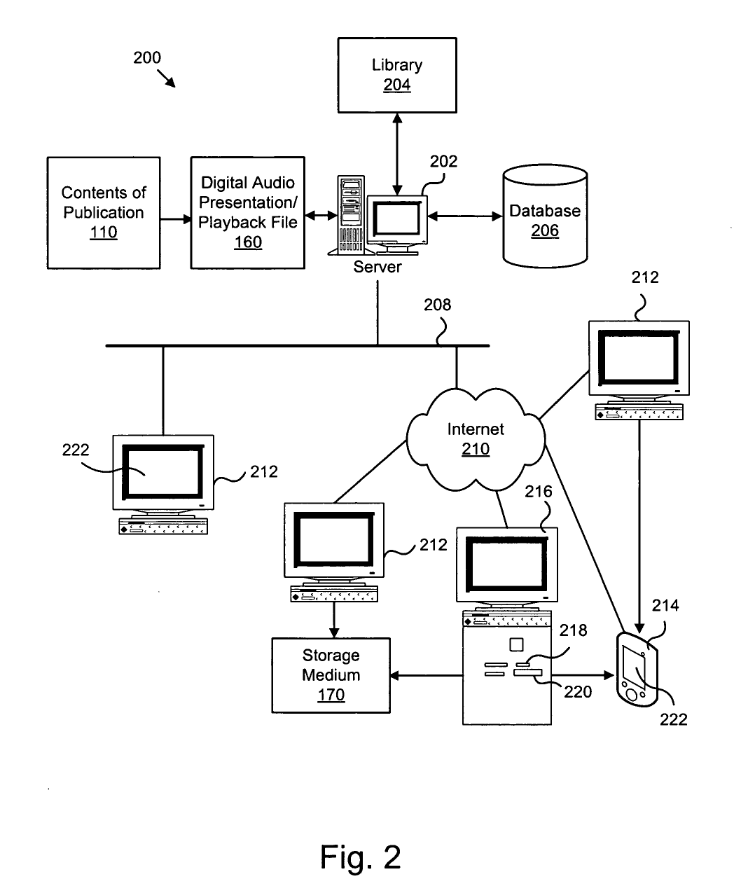

FIG. 2 illustrates one embodiment of a storage and delivery system 200 for digitally presenting the contents 110 of a printed publication 130. The storage and delivery system 200 as depicted includes a server 202 with a library 204 and a searchable database 206. The server 202 is connected to a network 208 including the internet 210. A plurality of client computer systems 212 are connected to the server 202 through the network 208 and have access to the searchable database 206 through the server library 204. In certain embodiments, the user can download and/or stream the digital audio presentation 160 to the client computer system 212 or the like. The visual or graphical content 154 of the digital audio presentation 160 may be viewed on a display 222, such as a monitor, LCD screen, digital display, or the like.

The digital audio presentation 160 may additionally be downloaded to a portable playback device 214. The portable playback device 214 may be an MP3 player, in certain embodiments, and may have audio and visual capabilities. In one embodiment, the digital audio presentation 160 is automatically downloaded to a client computer system 212 and/or a portable playback device 214 through a process commonly referred to as “podcasting.” A particular audio presentation 160, such as the contents 110 of a periodical, for example, may be requested through a subscription or the like to automatically download to a client computer system 212 or other storage medium on a regular basis.

Alternatively, a user may request to download and/or stream a specific audio presentation 160, such as an audio presentation of a book, magazine, instruction manual, or the like, and/or a portion of a publication, such as a magazine article, book chapter, article summary, or the like. In one embodiment, the user may select a variety of articles from various publications and download the corresponding audio presentations 160 to a client computer system 212 or storage medium 170.

In one embodiment, an electronic kiosk 216 connected to the internet 210 accesses the server library 204 and may be used to search the database 206. The electronic kiosk 216 may comprise one or more mechanisms 218 configured to accept payment, such as a credit or debit card, cash, tokens, or the like. In addition, the electronic kiosk 216 may include one or more mechanisms 220 for transferring or storing the audio presentation 160 onto a storage medium 170. For example, one or more selected audio presentations 160 may be downloaded through the kiosk 216 and stored on a CD or the like that is distributed to the consumer 140. Of course, any storage medium 170 capable of storing the audio presentation 160 or digital playback file 160 may be suitable, including a hard disk drive of a computing device or a portable playback device 214.

In a further embodiment, the kiosk 216 may store one or more digital playback files 160. In certain embodiments, the kiosk 216 may comprise a library 204 and/or a database 206. Consequently, the user may search the files 160 on the kiosk 216 and download the files 160 to a variety of storage media, such as through a wired or wireless connection, for example.

In one embodiment, the audio presentation 160 may be transferred to a portable computing device, such as a laptop computer, for example, through a wireless connection. Alternatively, a wired connection, such as through a USB connection or Ethernet connection, for example, may be used to transfer a digital playback file 160. In a contemplated embodiment, the user inserts a portable storage medium 170, such as a jump drive, memory stick, thumb drive, memory card, SD card, or the like, into a corresponding receptor 220 in the kiosk and downloads one or more digital playback files 160 to the portable storage medium 170.

The kiosk 216, which may be configured for retail or wholesale, may be located in a highly accessible area to facilitate distribution of the audio presentations 160. For example, the kiosk 216 may be located near public transportation such as a train station, airport, or bus stop, or near a point-of-sale station, such as in a book store or a coffee shop.

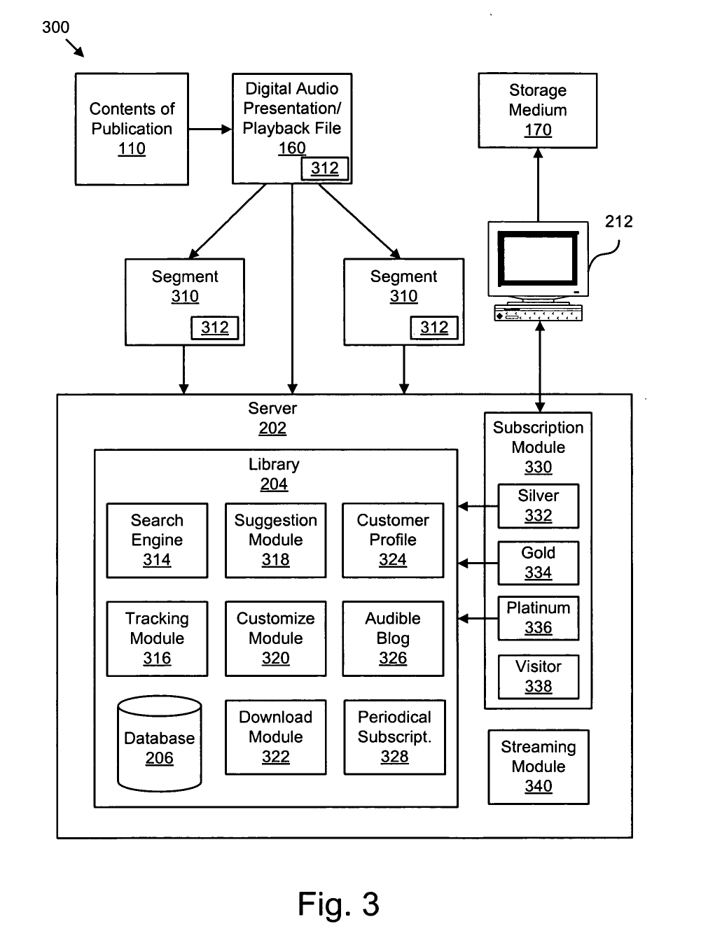

FIG. 3 illustrates in greater detail another embodiment of a storage and delivery system 300 for digitally presenting the contents 110 of a printed publication 130. The storage and delivery system 300 may include a server 202 with a library 204 in communication with a client computer system 212. One or more digital audio presentations 160 and/or segments 310 of a digital audio presentation 160 may be stored on the server 202 in the searchable database 206. The library 204 may include a search engine 314, a tracking module 316, a suggestion module 318, a customization module 320, a download module 322, a customer profile 324, an audible blog 326, and a periodical subscription 328.

A subscription module 330 may determine the level of access a user has to the library 204. In certain embodiments, the subscription module 330 includes a silver access level 332, a gold access level 334, a platinum access level 336, and a visitor access level 338. In addition, the server 204 may include a streaming module 340 to stream the contents 110 to a client computer system 212 and a podcasting module 342 to distribute the audio presentation 160.

As mentioned previously, the contents 110 of the publication 130 may be condensed, expanded, or revised. In one embodiment, at least a portion of a written segment of the printed publication 130 may be used to create one or more digital audio presentations 160. For example, the segment 310 may comprise a magazine article. Alternatively, the segment 310 may comprise a synopsis of one or more magazine articles or the like. The synopsis may represent the portion of a written segment in certain embodiments.

The digital audio presentation 160 and/or the segment 310 may be associated with one or more searchable identifiers 312 to facilitate searching the database 206. The searchable identifier 312 may include, but is not limited to, the title of a publication 130, the author, the date of publication, the title of a segment 310, the subject keywords, and the like.

The library 204 enables the user to search the database 206 for specific publications 130 and or segments 310 of publications 130. For example, the user may search for a subject key word, publication title, or the like, and the search engine 314 may search the identifiers 312 to identify all of the relevant playback files 160.

In certain embodiments, the tracking module 316 tracks the consumer activity within the library 204. For example, the tracking module 316, may track consumer purchases, searched terms, downloaded publications, new publication additions, consumer login activity, and the like. In one embodiment, the tracking module 316 tracks consumer activity to provide input to the suggestion module 318.

The suggestion module 318 may provide suggestions to the consumer. For example, if a consumer makes a number of queries for publications containing information about golfing techniques, the suggestion module 318 may use the query information to continue searching for publications featuring golfing techniques. Subsequently, if a related digital playback file 160 becomes available, the suggestion module 318 may compile a list of suggested or related materials. Similarly, if multiple consumers have purchased similar materials, the suggestion module 318 may suggest a popular playback file 160 relative to a consumer purchase or consumer profile 324.

The customization module 320 enables the consumer to customize an order and/or a subscription. Typically, if a consumer subscribes to a printed periodical or orders a printed publication, the consumer must purchase all of the content 110 within the publication 130. However, the consumer may only be interested in selected sections or segments 310 of the publication 130. For example, the consumer may desire to receive only the contents of the world news section of a newspaper and a brief summary of the articles featured in the local news section. The customization module 320 facilitates designing a content order, either for a one time purchase or for a regular subscription.

The customization module 320 may locate segments 310 of a printed publication 130 to create a customized order. As a result, the consumer has the option to “create your own” publication from available segments 310 of printed publications 130. In other words, the user may “mix and match” publication content 110 to create a regular subscription to a customized periodical or publication. For example, the consumer may subscribe to all periodical articles containing a selected subject keyword or to regular feature articles in certain magazines. The relevant articles or segments 310 may then be downloaded to the client computer system 212, to a storage medium 170, to a portable playback device, or other storage device.

The download module 322 facilitates downloading the selected segments 310 or digital audio presentations 160. As mentioned, the playback files 160 may be automatically downloaded to a client computer system 212 or the like according to a customer or user profile 324. For example, if the consumer wishes to subscribe to an audio presentation 160 of a selected section of a daily newspaper, or if the consumer has a regular periodical subscription 328 to a digital audio presentation, the download module 322 may regularly download the digital playback file 160 to the client computer system 212 as the files 160 become available. Alternatively, the consumer may login to actively download the available files 160. The subscription module 330 may limit the number of playback files 160 the consumer is able to download.

The customer profile 324 may be used to customize a subscription and to direct the suggestion module 318 and the customization module 320. In one embodiment, the customer profile 324 indicates user preferences, such as a preferred language, reader/voice, dialect, etc., for a digital audio presentation 160. The customer profile 324 may further contain personal information about the consumer such as interests and goals. The suggestion module 318 may subsequently use the personal information to suggest file downloads. In addition, the tracking module 316 may be used to supplement the information supplied by the consumer to determine suggested material.

The customer profile 324 may also facilitate determining an audible blog 326 and/or a periodical subscription 328. The audible blog 326, in one embodiment, enables the consumer to create a blog in an audio format. In certain embodiments, text-to-speech software or the like may be used to create an audio file for a blog.

The subscription module 330 may indicate a level of access available to the consumer. Additionally, the level of access may establish the number of downloads or regular subscriptions to which the consumer has access. In one embodiment, the level of access is determined by a monetary value. The monetary value may be equivalent to a monthly payment that enables the consumer to download a set number of digital playback files 160 or segments 310. Additional purchases or downloads may be charged per download in addition to the monthly fee. Alternatively, the level of access may be determined by a purchase quantity. For example, a consumer with several regular subscriptions 328 may be entitled to bonus downloads, on demand streaming, or other privileges.

The visitor status 338 may allow a consumer to purchase one or more downloaded files 160 without a regular subscription or monthly financial commitment. In addition, the visitor 338 may search the library database 206 without the benefit or commitment of a stored customer profile 324.

The streaming module 340 enables the consumer to enjoy an audio presentation 160 or segment 310 without downloading the full playback file 160. Streaming may be available to regular subscribers, in certain embodiments, or for sample listening.

The podcasting module 342 may use RSS syndication technologies to distribute the audio presentation 160 to client computer systems 212 and/or portable playback device. The podcasting module 342 may function as a subscription feed or web feed that automatically delivers new publication content 110 to a subscriber. Thus the subscriber may receive the audio presentation 160 without logging into the server website.

Of course, the audio presentation 160 may be made available to consumers through other forms of communication, such as satellite radio, radio broadcast, satellite TV, cable TV, and the like. In one embodiment, the audio presentation 160 of publication content may be available on demand using a TV or over the Internet by streaming the audio presentation 160. In addition, the audio presentation 160 may be part of a syndicated program. Those of skill in the art will recognize that coordinated audio data and visual data corresponding to the text content and graphical content of a printed publication may be distributed through a variety of communication networks or distribution methods. The present invention, therefore, is not limited to the illustrated embodiments.

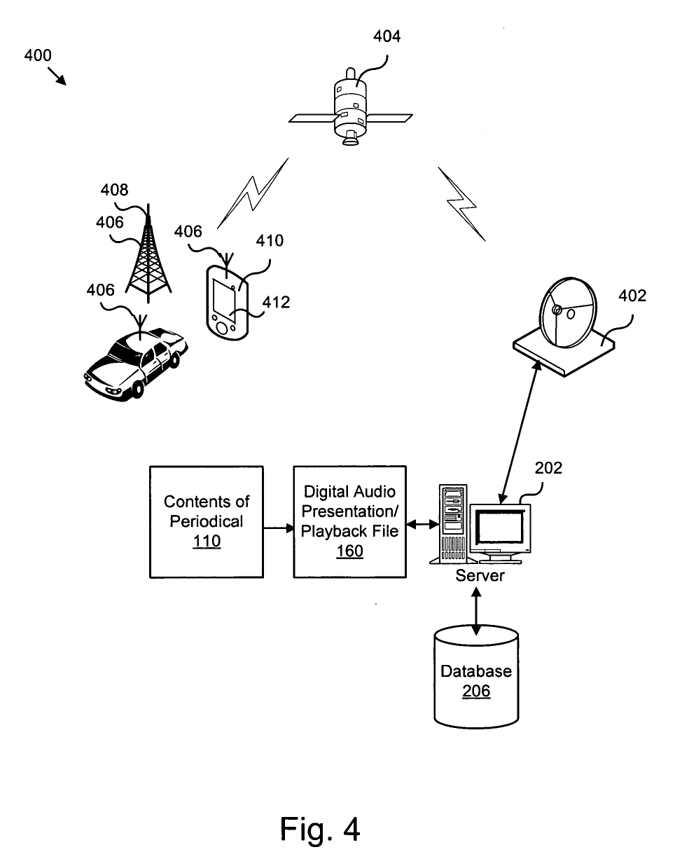

FIG. 4 illustrates another embodiment of a storage and delivery system 400 for digitally presenting the contents 110 of a printed publication 130. The system 400 as depicted includes a server 202 with a database 206 for storing one or more digital playback files 160, a ground station 402, one or more satellites 404, radio receivers 406, and a ground repeater 408. The system 400 may comprise a communication network embodied in a satellite radio network, or digital radio network. Typically, audio content can be broadcast through a satellite radio network to an area thousands of miles in diameter. In addition, hundreds of channels may be broadcast simultaneously through the satellite radio network.

The ground station 402 communicates with the server 202 to upload the digital audio presentation 160 and transmit a radio signal to one or more satellites 404 orbiting the earth. The satellite 404 transmits the signal back to earth, where the signal is received by the radio receivers 406. In certain embodiments, a ground repeater 408 may be used to reinforce the radio signal in metropolitan areas.

Digital radio receivers 406 are commonly integrated into vehicles radios for use while traveling. In addition, digital radio receivers 406, such as the depicted receiver 410, typically comprise a display 412 for displaying related data. In certain embodiments, the display 412 may be beneficial for displaying graphical content from a printed publication 130.

In a contemplated embodiment, a satellite radio channel may be dedicated to airing one or more digital audio presentations 160 of a printed publication 130. For example, the radio channel may broadcast content from a selected magazine or book. Alternatively, the radio channel may broadcast content from a plurality of magazines or newspapers. In one embodiment, publications 130 written by a certain author may be broadcast on a radio channel, including publication segments such as articles, chapters, and the like. The consumer may benefit from listening to and viewing contents 110 of the digital audio presentation through a digital radio receiver 406. Of course, a digital audio presentation 160 may further be broadcast on any communication or radio network, such as internet radio, satellite radio, short wave radio, traditional bandwidth, and the like.

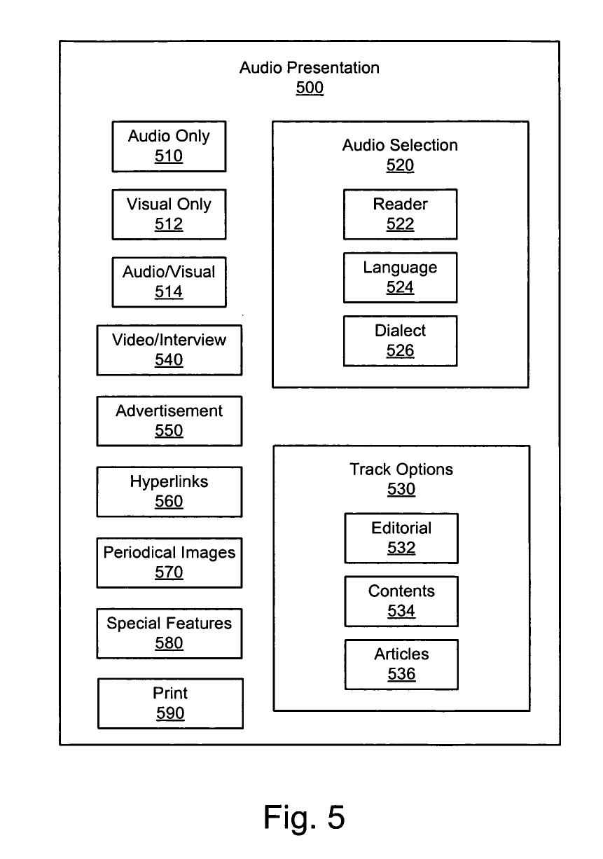

FIG. 5 illustrates one embodiment of an audio presentation 500 in accordance with the present invention. As depicted, the audio presentation 500 may contain an audio only format 510, a visual only format 512, an audio/visual format 514, a text only format 516, text content 517 and graphical content 518, an audio selection 520, a track option 530, video/interview option 540, advertisement 550, hyperlinks 560, publication images 570 special features 580, and print options 590. The audio presentation 500 offers the user various listening and viewing options. Of course, various combinations of features and options may be available, thus the present invention is not limited to the illustrated embodiment.

In certain embodiments, one or more digital playback files may selectively present an audio playback, a visual/graphical display, or a combination of both. In one embodiment, the selection is based on commands received to select audio only format 510, visual only format 512, audio and visual format 514, or text only 516. For example, the viewer may desire to view a text file of a magazine. Consequently, the viewer may select text only format 516. Alternatively, visual and audio format 514 may be provided but with the audio turned off, or vise versa. The audio data and the visual data may be coordinated and/or synchronized to play simultaneously; however, the playback device and/or the user may select to play one or the other or both.

In an alternative embodiment, the formats 510, 512, 514, and 516 may be digital playback files and may be automatically selected to run according the playback capabilities of a player. For example, a CD player with audio capabilities only may selectively play an audio only file 510. An MP3 player or DVD player with audio and visual capabilities may selectively play the audio/visual file 514. The file formats may determine the playback capabilities of an audio presentation 500. In a contemplated embodiment, standard formats enable the audio presentation 500 to be playable in common devices, such as hand-held processing devices, computers, CD players, MP3 players, DVD players, and the like. The audio presentation 500 may include, but is not limited to, audio files, audio/image files, image files, and audio/video files in certain embodiments.

The audio presentation 500 may be navigated similar to a known DVD or audio CD set up. For example, periodical articles may be recorded as tracks on a CD or chapters on a DVD. As a result, the user may skip tracks or select a chapter that contains desired information. Known set ups may also enable the user to easily select an audio selection 520, track options 530, or other available features.

The audio selection 520 may provide the user the option to select a listening track according to the reader 522, language 524, dialect 526, or the like. For example, the user may select a male celebrity to read the article or segment with a Brooklyn accent. Or the user may select a female voice to read the article in French. Consequently, the user may select a voice, language, and dialect that is pleasing or even entertaining if desired.

The multiple language option 524 may enable a consumer to have access to the contents 110 of the publication 130 that may not be printed in that specific language. For example, the text content 152, 517 of a magazine printed exclusively in English may be translated to Spanish or another language in order to create an audio file 158, or audio presentation 500. As a result, the consumer may enjoy the audio version of the translated content 110, where the content 110 may have been inaccessible previously. Accordingly, the magazine may benefit from a larger client base that includes multiple languages, but without increased printing costs. Furthermore, those who have difficulty reading a specific language or the like may benefit from an audio version. In addition, a selectable dialect 526 may further facilitate the listening process.

As mentioned previously, the reader 522 may be a human voice talent or a computer generated voice. In addition, computer technology may be used to create various language translations.

The track options 530 may function similar to audio tracks on CDs or chapter selections on DVDs. In one embodiment, the audio tracks are arranged in the order the articles are presented in a printed magazine. In this manner, a user may readily switch from the audio presentation 500 to a printed version of the publication without any confusion. The first track may comprise an editorial track 532 or a contents track 534 to familiarize the user with the articles 536 available for listening. The editorial track 532 may contain a brief summary of each available article 536. In another embodiment, an audio table of contents 534 may announce the titles of the articles or segments 536 available for listening. Alternative embodiments or formats may be configured to playback according to a layout or format required for a specific hardware or software player as needed.

In one embodiment, an audio presentation 500 may be formatted to play on an iPod™ or MP3 player with limited viewing capabilities. A visual image from a printed publication may be timed to be displayed on a display or screen at a designated moment during the audio playback. As the audio playback progresses, indicators within the audio presentation 500 may signal when to change the visual/graphical image. In one embodiment, the changing images correspond to the layout and organization of images in relation to text of the printed publication. Thus, the viewer may simultaneously listen to an article of a publication and view images associated with the presented text.

In another embodiment, the visual files include graphical images, graphical image sequences, and video files. Multimedia presentations with a combination of text, sound, graphics, and videos may be produced to convey content 110 from a printed publication 130. In certain embodiments, additional information may be used to supplement content 110 available in the printed publication 130.

Special features such as video/interview options 540, advertisements 550, hyperlinks 560, publication images 570, special features 580, and print options 590 may be available supplementary to or combined with the basic audio presentation 500. A user may select to view an exclusive interview or video footage 540 related to a particular article 536. In certain embodiments, the advertisements 550 in a selected publication may be read and recorded as an audible file. Advertisement clips may be included as headers or trailers to audio file tracks. Alternatively, advertisements 550 may comprise printable coupons, TV ads, movie trailers, radio ads, or the like. In one embodiment, advertisements 550 are scanned images that may be placed in a presentation similar to a graphic image. Advertisements may scroll or popup during an audio presentation 500. In addition, banners and animations may be used to present advertisement content 159.

Hyperlinks 560 may be provided to enable the user to access websites corresponding to advertisers, producers, related articles, or the like. Hyperlinks 560 may connect an image to a related information page, article, or advertorial. In one embodiment, hyperlinks 560 are embedded in text files to facilitate linking publication content with bibliographical information or other related sources. Hyperlinks 560 may provide a quick, valuable information resource not generally available in printed publications 130.

Certain special features may include video magazine content similar to that used on TV. The video magazine content may be provided in conjunction with or combined with the audio presentation 500. Once again, the supplemental information may be beneficial for the consumer as well as for the advertisers, the publishers, and the like.

Publication images 570 may be available to the consumer for viewing. In one embodiment, the printed layout of the publication 130 is scanned or stored in PDF files. Consequently, the user may electronically flip through the images 570 of the publication like the original publication using conventional PDF readers. Alternatively, the images 570 may be JPEG, GIFF, or another image format. As mentioned previously, text files 516 of publication content 110 and/or graphical images of text may also be available to the user.

Special features 580 such as additional articles, sound features, commercials, trailers, or the like may also be available. The special features 580 may comprise a library of supplemental content that is not featured in the printed publication 130 in certain embodiments.

Furthermore, the audio presentation 500 may have a print 590 option to enable printing in certain embodiments. Thus, the consumer may print articles, coupons, special features 580 or the like.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Additionally, the order in which a particular method occurs may or may not strictly adhere to the order of the corresponding steps shown.

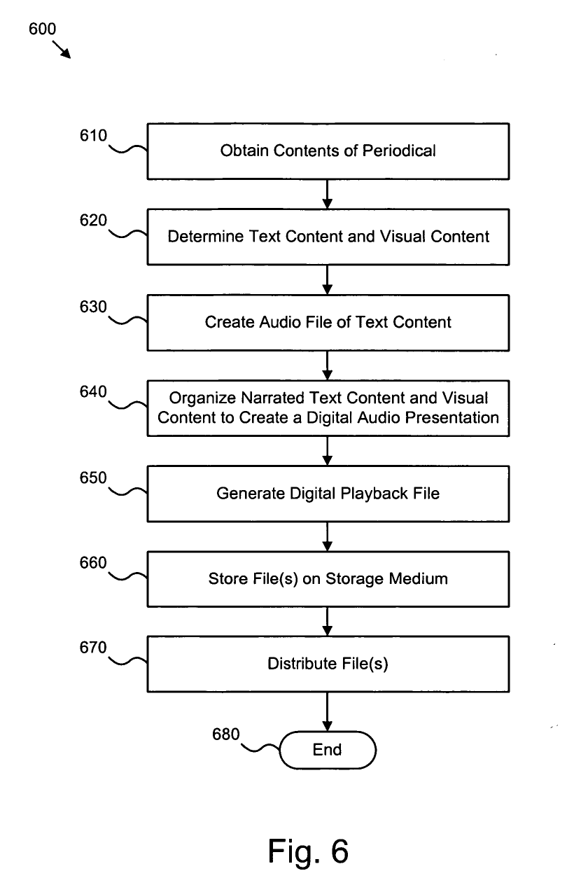

FIG. 6 illustrates one embodiment of a production method 600 in accordance with the present invention. The depicted production method 600 includes the steps of obtaining 610 contents 110 of a publication, determining 620 text content 152 and graphical content 154, creating 630 one or more audio files 158 of the text content 152, organizing 640 the narrated text content (or audio files 158) and the visual content 154 to create a digital audio presentation 160, generating 650 one or more digital playback files, storing 660 the file(s) on a storage medium 170, and distributing 670 the digital playback files. References made to embodiments illustrated in FIGS. 1-5 are for illustrative purposes only and do not, therefore, restrict the scope of the invention.

In one embodiment, the contents 110 of a publication 130 may be obtained 610 from the publisher of a publication 130, including advertisement content 159, and may include one or more digital files, such as text files of the written text, graphic files of illustrations, video files, animations, PDF files of the visual content, PDF files of the publication in the final layout format, PDF files of the advertisements, and high resolution graphic files of cover art images to create a corresponding cover for a storage medium 170 when desired. Other relevant files or information, such as videos, a hard copy of the printed magazine, music/sound effects, and the like, may also be gathered to enhance the digital audio presentation 160.

The producer 150 of the audio presentation may determine 620 the text content 152 to be read and recorded by a reader 156. A variety of readers 156, in one embodiment, may be used to create 630 audio files 158 of the text content 152. In one embodiment, the audio file 158 is an MP3 format. Other file formats may include, but are not limited to WAV, AIFF (Audio Interchange File Format), AAC (Advanced Audio Coding), RSS for podcasting, and OGG audio encoding and streaming technology.

The audio files 158 may be organized 640 in the order of the printed publication, in certain embodiments, and graphical content may be strategically placed to be viewed relative to the text content. In one embodiment, the audio files are tagged to bring up corresponding images at key points of the audio narrative. In one embodiment, advertisements are created and organized to play for 15, 30, or 60 seconds before or after featured articles. Limits may be placed on the number of advertisements allowable between articles. In one embodiment, the audio advertisements are placed at the end or beginning of an article track. Alternatively, the advertisement(s) may be compiled on separate tracks such that the user may easily skip advertisements if desired.

In one embodiment, the digital file(s) containing organized audio files 154 and visual content, such as text, graphics, video, etc., are reviewed and edited until a final format suitable for replication/duplication and distribution is created. One or more digital playback files may be generated 650 and stored 660 on a storage medium. In a contemplated embodiment, a “mastered” CD is created and tested and sent to a CD replicator along with the CD cover artwork.

A further step in the production method 600 may comprise distributing 670 the digital audio presentation. In one embodiment, a portable storage medium, such as a CD, DVD, DualDisc, memory card, or the like is shipped directly to the consumer. Alternatively, the portable storage medium may be shrink-wrapped to the printed publication or packaged within the publication. In a further embodiment, the digital playback files may be available on a website for download, streaming, radio broadcasting, podcasting, or the like. Downloads may be accessible with a membership, subscription, one-time download fee, or the like. For example, a single article may be downloaded or podcasted in MP3 format for a nominal fee.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for digitally presenting the contents of a printed publication, the method comprising:
obtaining contents of the printed publication;
determining text content and graphical content; and
providing at least one digital playback file configured to selectively present audio data and visual data corresponding to the text content and graphical content of the printed publication, wherein the audio data and the visual data are synchronized.

2. The method of claim 1, wherein the visual data is coordinated to trigger in time at a given time relative to the audio data.

3. The method of claim 1, wherein the method further comprises obtaining advertisement content and wherein the at least one digital playback file includes audio data and visual data corresponding to the advertisement content.

4. The method of claim 1, wherein the method further comprises coordinating the audio data and visual data to playback the text content and the graphical content consecutively relative to the printed layout of the printed publication.

5. The method of claim 3, wherein the method further comprises coordinating the audio data and visual data to playback the advertisement content interspersed with the contents of the printed publication.

6. The method of claim 1, wherein the method further comprises providing a hyperlink to connect the contents to a related resource.

7. The method of claim 1, wherein the method further comprises storing the at least one digital playback file on a storage medium.

8. The method of claim 1, wherein the method further comprises storing the at least one digital playback file on a portable playback device.

9. The method of claim 7, wherein the method further comprises distributing the storage medium and the printed publication collectively.

10. The method of claim 1, wherein the contents of the printed publication comprise at least a portion of a written segment.

11. The method of claim 10, wherein the at least a portion of a written segment is associated with a searchable identifier and the method further comprises storing the at least a portion of a written segment on a server comprising a searchable database accessible through a network.

12. The method of claim 10, wherein the method further comprises associating the at least a portion of a written segment with a purchase cost and transferring the at least a portion of a written segment to one of a client computer system and a portable storage medium.

13. The method of claim 10, further comprising distributing the at least a portion of a written segment with the printed publication.

14. The method of claim 1, wherein the method further comprises broadcasting the audio data and visual data over a communication network.

15. The method of claim 14, wherein the communication network is selected from the group consisting of internet radio, satellite radio, short wave radio, and traditional bandwidth radio.

16. The method of claim 1, wherein the method further comprises vending the at least one digital playback file from an electronic kiosk configured to accept payment and transfer the at least one digital playback file to a storage medium.

17. The method of claim 1, wherein the method further comprises electronically distributing the at least one digital playback file on a network according to a user profile.

18. An apparatus for digitally presenting the contents of a printed publication, the apparatus comprising:
contents of the printed publication, wherein the contents comprise text content and graphical content;
at least one digital playback file configured to selectively present audio data and visual data corresponding to the text content and graphical content of the printed publication, wherein the audio data and the visual data are synchronized.

19. The apparatus of claim 18, wherein the text content and the graphical content are coordinated to playback consecutively relative to the printed layout of the printed publication.

20. The apparatus of claim 18, wherein the audio data comprises a voice recording of the text content of the printed publication created by one of human voice talent and automated computer voice.

21. The apparatus of claim 19, wherein the voice recording is selectable from a plurality of voice recordings, and wherein the voice recording is selected from the group consisting of dialects, languages, children's, and male and female voices.

22. The apparatus of claim 18, wherein the audio data comprises a sound byte.

23. The apparatus of claim 18, wherein the visual data is selected from the group consisting of graphical images, graphical image sequences, video files, pictures, and animations.

24. A system for digitally presenting the contents of a printed publication, the system comprising:
contents of the printed publication, wherein the contents comprise text content and graphical content;
at least one digital playback file configured to selectively present audio data and visual data corresponding to the text content and graphical content of the printed publication, wherein the audio data and the visual data are synchronized; and
a server configured to store the at least one digital audio playback file, the server comprising a searchable database accessible through a network.

25. The system of claim 24, wherein the system further comprises an electronic kiosk in communication with the server, the electronic kiosk configured to accept payment and transfer the at least one digital playback file to one of a client computer system and a portable storage medium.
